(19) United States
(12) Patent Application Publication
(10) Pub. No.: US 2005/0123385 A1
(43) Pub. Date: Jun. 9, 2005

(54) Unloading system for particulate material

(76) Inventor: Jason R. Kirsch, St. Brieux (CA)

Correspondence Address: THADDIUS J. CARVIS, 102 NORTH KING STREET, LEESBURG, VA, 20176, US

(21) Appl. No.: 10/932,623

(22) Filed: Sep. 2, 2004

Related U.S. Application Data
(63) Continuation-in-part of application No. 10/619,258, filed on Jul. 11, 2003.

(30) Foreign Application Priority Data
Jul. 12, 2002 (CA) 2,393,119

(51) Int. Cl. B65F 9/00

(52) U.S. Cl. 414/573; 414/575; 414/482; 198/302; 198/313

(57) ABSTRACT

This invention concerns a new grain unloading system using an integrated ramp, horizontal transfer conveyor and elevating conveyor. The unit is towed, positioned and activated by an agricultural tractor.

### PRIORITY CLAIM

Priority is claimed based on Canadian Patent Application No. 2,393,119, filed Jul. 12, 2002. This application is a continuation-in-part of prior copending application Ser. No. 10/619,258, of the same title and inventor, filed Jul. 11, 2003, priority to which is also claimed.

### FIELD OF THE INVENTION

This invention is in the field of particulate material unloading systems, and particularly addresses improvements in efficiency and ease of use of systems for unloading granular agricultural materials from transport vehicles into storage bins or other generally larger transport vehicles.

### BACKGROUND

In farming, “grain augers” are commonly used to unload granular agricultural materials from trucks into bins.

Over the years, the scale of farms and of the equipment used in farming has progressively increased. Formerly, loading/unloading augers were relatively small and light, and it was possible for a physically fit operator to manually position them for use (operation). It was also possible for a reasonably skilled operator to back up a simple dump truck and position its discharge chute over the inlet of a material transfer auger. Also in the past, a helper was often available to assist with the physical movement of equipment and to provide guidance in positioning the truck.

As large grain auger/conveyors have come into use, it is no longer possible to or easy to practically position them by hand, and some are sufficiently large to require a tractor to tow, position and actuate them.

Much less manoeuvrable belly-dump semi-trailers and highway tractor trucks are now often utilized to haul agricultural materials rather than end-dump grain trucks. It is much more difficult or at times impossible to manoeuvre a semi-trailer or highway tractor trucks into position relative to a conventional unloading system.

Work on a grain farm is seasonal in nature, and opportunities for full time employment have continuously decreased over time. Consequently, there has been less and less labour available on the typical farm. Whereas in the past another person may have been available to assist with positioning equipment, that is no longer the case in many situations. To compound the problem, the age of the farming population has increased significantly and farmer operators are less able to perform physically demanding tasks. Safety is also an issue when an operator is working alone, as farmers are often required to do.

With fewer available operators, the time of the farmer/operator is increasingly valuable. Time-consuming, low value-adding physical operations must be minimized in the interest of improved economies of scale and the avoidance of personal injury.

With current economic pressures, farming operations increasingly demand equipment that is safe, simple and easy to use and maintain, cost effective, and which offers the highest possible overall efficiency of use.

To address current needs, industry has responded with innovations in unloading system design. Various adaptations of existing equipment have been devised.

Swing-Away Conveyor Systems:

The current standard in the industry is the swing-away type screw auger that is towed and activated by an agricultural tractor. Such a system is disclosed in U.S. Pat. No. 4,963,066 to Boppart and U.S. Pat. No. 4,603,775 to Plett. The system has a lower, swingable transfer auger portion that is swung under a grain trailer's unloading chutes. The lower transfer auger then unloads into the main transfer auger. This is a somewhat cumbersome system that requires the swingable auger to be swung under the grain trailer and removed each time the trailer is unloaded. If the trailer is a B-train type or a Super B-train type™, meaning two trailers with a fifth wheel pivot and a set of two or three axles respectively located in between the unloading chutes or groups of unloading chutes of each trailer, the swingable auger has to be swung under and from under each of the trailers.

As illustrated in Boppart, the tractor is connected to the swing-away auger system at the outboard lower end of the main transfer auger. The swing-away portion is then typically approximately 90 degrees to the main transfer auger to allow the grain trailer to approach the unloading system close enough to allow for unloading. This arrangement is often not convenient or even suitable for some yards where the ability to manoeuver the highway tractor unit and the grain semi-trailer is restricted by the grain bins themselves, buildings, overhead power lines or trees, et cetera.

U.S. Pat. No. 6,068,103 to Werner discloses an alternative swing-away auger extension. Westfield's MK Series™ grain augers are present-day swing-away conveyor systems.

Generally with swing-away type conveyor systems, a sometimes awkward, less than ideal positioning of the main conveyor and its power unit is required. This type of system requires cumbersome manual handling of the swing-away auger extension before and after unloading, and for each trailer and often for each unloading chute in a semi-trailer train. Typically the user has to jockey the auger conveyor, the semi trailer and tractor unit, truck, or both.

Ramp/Ramp Over Systems:

In an attempt to improve upon the swing-away auger system, various types of ramps and combinations of ramp and self-contained intermediate transfer augers have been devised which make it possible to simply drive a truck or semi-trailer over the inlet of the transfer auger system; facilitating use and eliminating the need for repositioning of the unloading equipment for each truckload. One such system is manufactured by Westfield™.

In the Westfield™ device, the ramp system is simply placed over the hopper of a conventional swing-away auger system. This approach still has serious drawbacks in that such a ramp is typically too large to be handled manually and requires another tractor to carry and position it. Otherwise, the tractor that is being used to power the auger needs to be disconnected from the main elevating device for use in repositioning the ramp, and re-connected to the conveyor thereafter. The process needs to be repeated each time the conveyor system is moved to a different bin. The positioning of auger and its power unit remain somewhat awkward and less than ideal. Initial manual handling/positioning of the swing away auger extension and separate handling of the ramp is required.

The Feterl Mfg. Co. provides a “Drive Over Hopper” which is a combined transfer conveyor and ramp that connects to a main conveyor. An agricultural tractor powers both conveyors simultaneously, with the power shaft for the main conveyor passing through the Drive Over Hopper. Limited-distance movement of the Drive Over Hopper and main conveyor together is provided by hitching the main conveyor to the end of the Drive Over Hopper. However the manufacturer cautions that two separate towing vehicles are required for transporting, and recommends against long distance transport of the Drive Over Hopper.

The Drive Over Hopper and the main conveyor of the Feterl system are essentially each a simple trailer unit. The wheels of each unit are mounted in a fixed direction of travel relative to their respective frames and the units are hitched end to end for limited distance movement. When two trailers are thus connected in series, it is very difficult to back them up any significant distance. In the Feterl system, backing up the Drive Over Hopper while connected to the main conveyor to position the outlet of the main conveyor over the inlet of a grain bin would be extremely difficult, if not impossible.

In the operating, unloading position, the outlets of the inclined transfer conveyors of the Drive Over Hopper are in close proximity to the inlet hopper of the main conveyor. Damage would occur to the unit due to interference between these components as a result of relative movement in transport. The Feterl system therefore provides for extension of the hitch between the Drive Over Hopper and the main conveyor to prevent unwanted contact and damage. Extending the hitch and possibly disconnecting the drive train to do so is a further time consuming inconvenience for an operator.

The Feterl Drive Over Hopper platform has a rigid hitch. To provide for lifting the front end of the system off the ground for transport the rigid hitch is connected, via a tow bar, to the lower, lifting links of a tractor's three-point hitch. At the center of the tow bar, a pivoting connection to the platform hitch allows the tow bar and tractor to turn relative to the Drive Over Hopper. The drawback with this is that 100+horsepower tractors that are widely used to operate large grain conveyors are often not equipped with a three-point hitch. Therefore, many farmers are not equipped to use the Feterl system. In contrast, the pivoting hitch of the present invention is designed to be connected to the drawbar of the towing tractor, which allows use with any tractor large enough to tow and power the unit.

A further drawback of the Feterl Drive Over Hopper is that the ramps must be manually folded and unfolded.

Separate Transfer Conveyor/Ramp System:

A separate horizontal transfer auger, alone or in combination with a drive-over ramp is another approach that has been employed to improve upon the ease and efficiency of unloading agricultural materials, as illustrated in the Portable Pit™ device.

This device includes a frame with a pair of support wheels and a hitch. Connected to the frame is a pit with manual, spring-assisted, folding ramps. There are twin screw lateral transfer augers located at the bottom of the pit. In addition, there is a single screw intermediate auger. Thus the whole device is built into a trailer-type unit.

The ConveyAll™ belt-type conveyor similarly has a ramp. However, this device uses an endless belt rather than screw lateral transfer augers and has a ramp detachable from the transfer conveyor.

With both of these systems, there are either one or two components (transfer conveyor and ramp) in addition to the main conveyor that must be handled/positioned each time the loading system is relocated. The components are too large to be handled manually so another tractor is required to carry and position the components. Otherwise, the tractor that is being used to power the main conveyor needs to be disconnected, and re-connected before and after the positioning of the intermediate transfer unit and ramp. That process needs to be repeated each time the auger is moved to a different bin.

Other devices use an expensive, separately powered intermediate transfer system.

U.S. Pat. No. 5,964,566 to Stewart et al discloses a portable, drive-over hopper that comprises a substantially horizontal, paddle-type transfer conveyor. A belly-dump truck may be easily positioned over the hopper of this invention for unloading bulk granular materials. This transfer conveyor also comprises a removable tow hitch and transport wheels to provide for easier relocation of the unit. One disadvantage of this invention is that the horizontal transfer conveyor must be towed and positioned separately from the elevating conveyor into which it is intended to discharge. A further disadvantage is the need to manually elevate the hitch for attachment to the towing vehicle, and to install and remove the transport wheels. Yet another disadvantage is the need to manually fold the ramps for transport.

Unloading systems, as developed to date, are typically cumbersome, complex and costly and leave unaddressed, opportunities to further increase cost effectiveness. Either a separate tractor is required to position the equipment or it is necessary to disconnect the tractor that is powering the unloading auger for the purpose of positioning a ramp and/or an auxiliary auger system. Each piece of the unloading equipment system must still be separately positioned when moving from one bin to another, consuming valuable time. Complexity leads to more required maintenance, a higher probability of breakdown and increased costs. High cost compounds the economic pressures on farming operations.

Integrated Systems:

Another attempt to overcome the drawbacks associated with systems made up of separate material handling components comprises an integrated belt conveyor with ramps, a flexible-walled hopper and drive-over belt conveyor. This device is named INNO-Veyor™.

One benefit of such a device is that it allows more convenient positioning of the elevating auger relative to the bin. The lateral transfer section, complete with ramps is integrated with the elevating section, eliminating the need for separate handling and positioning of ramps and transfer section. In addition, the lateral transfer section and elevating section share a common towing/power unit. Finally, the unit incorporates a hitch, and wheels under the main conveyor for transporting the entire unit.

One of the problems with this system is that it is limited to a belt-type conveyor, to be able to drive upon it without damaging it. The system also requires a heavy transfer structure also to enable driving on it. Another problem is the relatively narrow opening to receive material because the width of the belt is limited to that which can be used in the elevating section. Also, the structure/mechanism needed to support and operate a drive-over belt may be relatively tall which limits the clearance between the belly dump chute of a grain trailer and the flexible hopper above the device and also the size of the opening into which material can be dumped.

The INNO-Veyor™ unloading system does not incorporate transport wheels to support the trailing end of the lateral transfer section and the lower end of the main conveyor. As a result, the lateral transfer section, main conveyor and the connection between them must be rigid and must be sufficiently strong to support the weight of the system at this connection. While it is possible to build these components heavy enough to support this weight, it is not economical to do so.

The present inventor believes that a hydraulic cylinder is used to position and hold the joint rigid between the lateral and elevating sections of the device.

It seems to the present inventor that if an error is made in positioning the transfer section for use, or if part of the lateral transfer section sinks into soft soil under the weight of the truck/trailer, an undue stress would be imposed on the structure.

U.S. Pat. No. 6,471,031 which issued to Stanley R. Duncalf discloses a material handling conveyor adapted for ease of hitching to a towing vehicle. A substantially horizontal transfer conveyor portion is pivotally connected to an elevating conveyor portion and the horizontal transfer conveyor portion comprises a hitch. One or more hydraulic cylinders are provided for positioning the horizontal transfer conveyor portion and hitch for ease of connection to the a towing vehicle. This patent does not address the difficulties in an agricultural situation where bulk particulate materials must be unloaded onto the conveyor from large, difficult to manoeuver, multi-trailer, highway tractor truck units. Neither ramps nor means for positioning the conveyor inlet under the outlet of a belly dump trailer are provided.

It is an object of the present invention to improve upon existing particulate material unloading systems that are presently made up of a number of separate components which can include a main elevating conveyor; a separate auxiliary horizontal transfer conveyor; an integrated swing away horizontal transfer conveyor; and a separate ramp system. It is a further object to dispense with separate handling and positioning of separate components and eliminate the need to disconnect and reconnect a motive power source.

Specifically, it is an object of this invention to provide, in a particulate material unloading system: an integrated main conveyor and transfer conveyor complete with an integrated drive-over ramp and platform such that the complete system is contained in a single unit and the complete system may be towed and positioned by a motive power source, without having to disconnect the motive power source or any of the components of the system each time the system is transported to a different location.

It is a further object to make the positions of conveyor and truck tractor trailer(s) unit more normal and convenient, and to provide all functions powered by and conveniently and remotely operated from the motive power source, including operation of ramps, transport wheels, hitch and conveyors without having to disconnect the vehicle motive power source. It is also an object of this invention to provide power actuated ramps for ease of use and easy positioning of truck tractor and trailer(s) units for unloading; said ramps being foldable for narrow transport width; said system having no requirement for manual effort in the operation, apart from operating powered equipment through remote controls; said system providing power actuated transport wheels and hitch for ease of changing from operating to transport position; said system further providing articulation between auxiliary and main conveyor as well as support by transport wheels such that no portion of the weight of a truck tractor and trailer(s) unit on the ramp/platform is transferred to the main conveyor; towing for transport is accommodated without having to provide a completely rigid joint between auxiliary and main conveyors; and relative vertical movement in transport is accommodated and does not impose strain on either transfer or main conveyor structure; said system further providing the option of using different types of conveyors that may be preferred, including auger/screw, belt, paddle, and bucket; said invention providing a conveyor drive train connection at the hitch so that conveyors are driven by the tractor and the drive need not be disconnected for transporting. Another object is to provide a truck position indicator means to facilitate aligning truck trailer unloading chutes and hoppers with the material receiving area of the unloading system.

### SUMMARY OF THE INVENTION

Therefore, this invention seeks to provide an integrated particulate material transfer system adapted to be towed, positioned and activated by a motive power source, namely an agricultural tractor; said device including:
an elongated horizontally disposed platform;
said platform being supported at one end by at least one retractable castoring transport wheel, and at an opposite end, by a movable hitch; said hitch adapted to be pivotally connected to said motive power source;
pivotally attached hydraulically operated ramps;
said platform containing transfer means for conveying particulate material from the platform to a main transfer conveyor; wherein said motive power source and said integrated material transfer system, when used together, are always connected for both operation and transport.

This invention also seeks to provide an integrated mobile unloading and conveying device for particulate material adapted to be towed, positioned, and activated by a motive power source, said device including:
an elongated horizontally disposed platform;
said platform being supported at one end by a pair of retractable castoring transport wheels, and at an opposite end by a hingedly connected hitch; said hitch adapted to be pivotally connected to said motive power source;
a rearward and a forward pair of hydraulically operated foldable ramps; said ramps being transverse to said platform, parallel to one another, and extending outwards from both sides of said platform;
each of said forward and rearward pair of foldable ramps including a centre section which is integrally connected with and forms a portion of said platform;
at least one first horizontally disposed transfer conveyor located within said platform, and adapted in operation to move particulate material rearwardly within said platform;
said at least one transfer conveyor being connected by articulated joints to at least one obliquely disposed second transfer conveyor;
said at least one second transfer conveyor being connected at a remote end to a main elevating conveyor by a pivotal joint;
said second transfer conveyor in operation adapted to discharge particulate material into said main conveyor; said platform further including on its upper side a particulate material receiving aperture adapted to receive contents of a vehicle transporting particulate material;
said aperture being located between said forward pair and said rearward pair of ramps;
wherein in operation, when said hitch is raised at its forward end and said transport wheels are retracted, said platform is in an operating unloading position adapted to receive and convey particulate material; and when said transport wheels are extended and said hitch lowered, said device can be transported to another location such that a remote end of said main conveyor can be positioned to discharge its contents into a desired storage facility.

The main conveyor is conventional except at its lower end where it attaches to the unloading system platform. The main conveyor can be one of a number of conventional types of conveyor. The main conveyor is supported at approximately its midpoint by a structure that extends downward to a pair of main transport wheels. As is typical in the industry, this supporting structure incorporates a means for raising and lowering the main conveyor tube.

The lower end of the main conveyor and the adjoining trailing end of the platform are supported by a pair of retractable platform transport wheels. These wheels are retracted (hydraulically) to lower the trailing end of the platform onto the ground for operation and extended to raise it for transport of the system.

A linkage is provided from the transport wheels to a pivoting tow hitch such that when the transport wheels are retracted the towing hitch is also raised, lowering the leading end of the platform to the ground as well.

To maintain stability in transport, all wheels of the system must remain on the ground as the unit is transported. This is accomplished by providing articulation at the lower end of the main conveyor tube. The main conveyor tube is sectioned near its lower end. A pair of mating flanges, appropriately slotted and constrained in sliding rotation pivotally connect a short, lower stub section of the main conveyor housing to the rest of the conveyor housing. This provides for rotation of the lower stub tube relative to the main conveyor tube around their coincident longitudinal axes.

The sides of the lower stub tube are apertured to receive material from a pair of smaller conveyors that are extensions of and carry material from the platform conveyors. A pivotable joint similar in design to that between the main and stub tube connects these small conveyor housings to the main conveyor stub tube. This pivoting arrangement allows for a change in the angle between the platform and the main auger, which is necessary both when the system is transported over uneven terrain, and when the platform is lowered or raised in preparation for operation or transport. When these small conveyors are screw augers, they are driven through flexible joints at the output ends of the platform screw augers.

A set of ramps have centre sections which are integrally attached to the platform to permit a truck to drive over the platform. The ramps are foldable to provide for narrow transport width, and hydraulically powered for ease of use. The platform is provided with an aperatured upper surface for receiving particulate material from a hopper or tailgate outlet of a truck. The platform houses substantially horizontal transfer conveyors for conveying material from the material receiving area of the platform to the main conveyor. The platform conveyors are powered by the towing tractor. The main conveyor is also powered by the towing tractor. The drive for the main conveyor passes through the platform.

A hitch is mounted on the end of the platform opposite the main conveyor. The hitch is hinged to the platform and linked to the platform transport wheel mechanism. As the platform transport wheels are actuated to raise or lower the conveyor end of the platform, the hitch moves to raise or lower the hitch end of the platform. The hitch thus supports the platform for transport, and is allowed to pivot on its hinge to lower the platform to the ground for operation of the unloading system, without having to uncouple the towing vehicle from the unloading system. A manually operated hitch jack is provided for supporting the hitch end of the system when a towing vehicle is not connected.

A system may also be provided for assisting a truck driver in properly positioning a truck/trailer outlet over the unloading system. This feature may consist of a retractable cord or tape that can be marked to correspond to the driver's position when each truck/trailer outlet is properly positioned. Once the system is calibrated, a driver need only stop the truck when the driver's position corresponds to a mark on the cord/tape and the respective outlet will be properly positioned over the unloading system.

In operation, the operator connects the towing vehicle (tractor) to the hitch, and raises the hitch jack's base off the ground and stores the jack. He then connects hydraulic power from the towing vehicle to the platform and connects the conveyor drive which is powered by the power take off of the tractor. The operator tows the unit to a desired position with the conveyor outlet aligned with a material storage facility inlet. Thereafter, the operator actuates the hydraulic circuit to lower the entire platform to rest on the ground (i.e. retract platform wheels and raise hitch) and unfold ramps and lay them out on the ground. The system is now ready to unload a vehicle. A particulate material transporting vehicle is driven over the ramps and positioned with a hopper outlet over the platform inlet. Thereafter, the conveyor drive to the towing/powering vehicle is engaged and the particulate material transporting vehicle hopper is opened to discharge the material into the unloading system inlet on the platform. When it is desired to move the unloading system to a different material storage facility, the hydraulics are reversed to prepare the unloading system for transport.

In summary, this invention also seeks to provide a particulate material unloading system with total integration of ramp/platform and conveyors, including powered, folding ramps for convenience and ease of use. It has a powered, co-actuated platform suspension for transport (platform wheels and hitch). Any type of conveyor can be used. The unit is towed/positioned and activated by the same vehicle (tractor) without having to disconnect the towing vehicle. All towing, positioning and operating functions are conveniently and remotely operated from the tractor cab. Finally, the transfer and main elevating conveyors are hinged where they join to provide necessary flexibility in transport and to allow the platform to rest on the ground for operation at any necessary angle relative to the main conveyor.

### BRIEF DESCRIPTION OF THE DRAWINGS

The invention will be more fully described in conjunction with the following drawings wherein:

FIG. 1 is a schematic perspective view of the unloading device of the present invention. Some parts, as well as the left rear ramp, have been removed;

FIG. 2 is an enlarged view of the rear portion of the device shown in FIG. 1;

FIG. 3 is a further enlarged view of the rear portion of FIG. 2;

FIG. 4 is a cut away portion of the central section of the unloading device from a perspective view with some components removed;

FIG. 5 is an enlarged view of the front portion of the device with some components removed;

FIG. 6 is a view of the rear portion of the device taken from above and to the rear of the device;

FIG. 7 is a side view of the device, showing it in a transport position;

FIG. 8 is a side view of the device in the unloading or working position; and

FIG. 9 is a detailed perspective view of the device showing the actuating mechanism for the transport wheels, in the transport position.

### DETAILED DESCRIPTION OF THE INVENTION

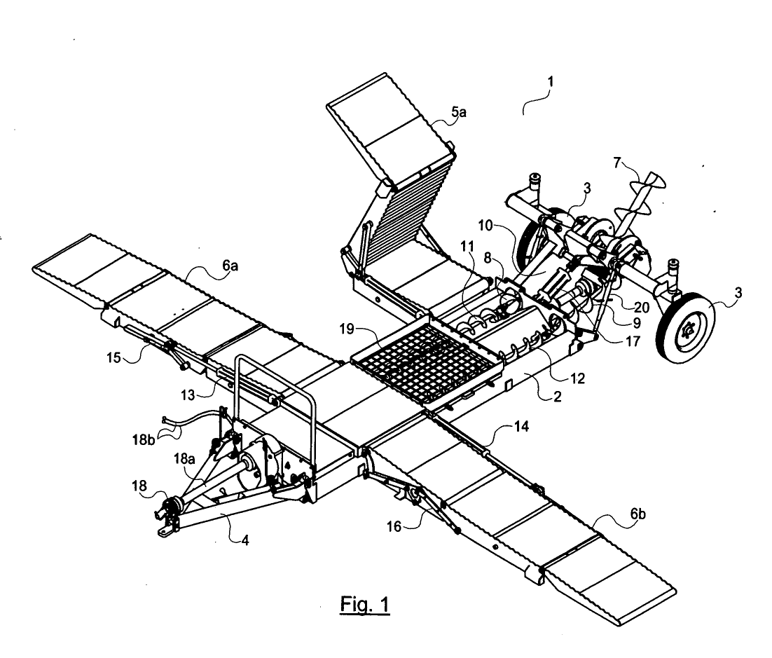

FIG. 1 gives an overall perspective view with some portions cut away or removed of the present invention shown generally as 1. The unloading device for particulate material, and more specifically for unloading grain from trucks and moving it into bins, has a generally longitudinal platform 2 which is supported at the rear end by retractable castoring transport wheels 3 and at the front end by a hingedly connected hitch 4. The invention has a pair of right and left ramps at the rear and at the front. The centre portions of each of the front and rear ramps are integrally connected and form a portion of said platform.

In FIG. 1, the rear right ramp which is foldable is marked as 5a, while 5b has been removed for clarity of illustration. The front pair of ramps are marked as 6a and 6b. The ramps are parallel to one and other and spaced apart to allow a large grain truck, in fact, even an 18-wheeler, to drive up and then down the opposite side while unloading of material through cargo discharge apertures located on the bottom of the truck. The truck is generally positioned such that a discharge orifice would be centered over the central collection bin or opening marked as 19.

Grain is moved upwards through a main auger-type conveyor marked as 7. The grain is deposited into stationary grain storage bins, through the tops of the bins (not shown). The main horizontally disposed transfer conveyors are located within the platform and move material from the discharge opening area 19. These conveyors are marked on the right-hand side as 11 and on the left hand side as 12. These transport conveyors 11 and 12, in operation, move grain rearwardly to articulated smaller rear transfer conveyors 8 and 9. The transfer conveyors 8 and 9 discharge the grain at their upper ends into the main conveyor 7. The ramps 5a, 6a, 6b and 5b (not shown), are hydraulically foldable to allow narrow transport width, i.e. to move the unloading device down highways, roads or through crowded areas. The front right ramp 6a is actuated to a folding position by hydraulic cylinder 13 and the left-hand side front ramp 6b is actuated to the folding position and working position by hydraulic cylinder 14. Linkages 15 and 16 are attached to right-hand front ramp 6a and left-hand front ramp 6b. Similar linkages and hydraulics are found in the rear right and left ramps but are not marked.

In order to move the device from a transport position where it can be pulled by a power source, hydraulic cylinder 17 tilts the rear axle and the transport wheels from an extended position to a retracted or unloading position. Clearly, platform 2 must be secured firmly on the ground in order to avoid breakage when large trucks move over the platform via the ramps 5a, 6a et cetera. The movement of the ramps, transport wheels position and hitches are all accomplished by means of hydraulics which attach to the power source which is generally an agricultural tractor. The power for the conveyors is provided by the power takeoff (PTO) of the agricultural tractor. Numeral 18 indicates the shield on the first universal joint on the PTO shaft 18a. Hydraulic connection hoses are marked 18b.

The present invention can be actuated totally by a single operator in the power source and there is no need for manual lifting or moving of parts. The operator can remain at the power source and simply move the device to the correct position and fill one grain bin after another. The only other operator necessary is one to drive the truck in position over the ramp and the discharge area 19.

Moving the transport wheels from the extended to retracted position coincides with raising the hitch 4 and vice versa by means of a linkage to be described later. Turnbuckles 20, located on each side of the rear of the vehicle platform, adjust the linkage between the two.

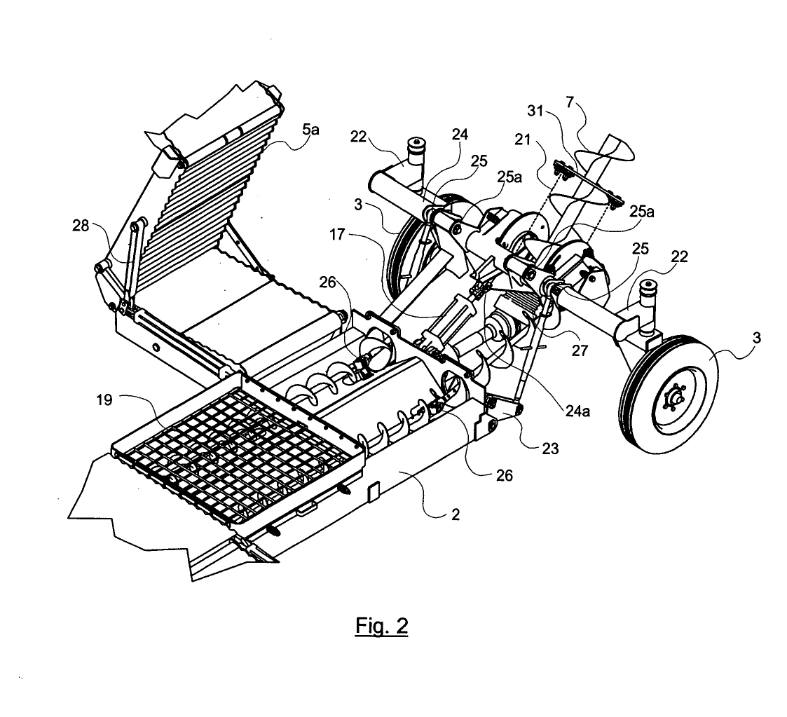

FIG. 2 is an enlarged view of the rear of the vehicle with a number of other portions labelled. For example, conveyor 7 is enclosed within conveyor tube 21 (shown in phantom). Transport wheels 3 are supported by wheel holders 22 which are attached to the main axle frame tube 24 that is rotated by hydraulics cylinder 17. Pivotal joints marked 25a permit the hydraulics to move the transport wheels 3 from a retracted to an extended position to be shown in later drawings. Turnbuckles 20 are attached to the platform pivotally on bell links 23. Transfer conveyors 11 and 12 are connected to smaller rearward articulated conveyors 8 and 9 by means of u-joints 26. The main elevating conveyor 7 is attached to a main drive shaft by means of a lower articulated stub section 27, which is basically the main drive CV joint. This joint allows the axle frame member 24 to pivot rearwardly and forwardly and not to affect the main conveyor 7. In FIG. 2, one notes the linkage to foldable right rear ramp 5a is more clearly shown as 28.

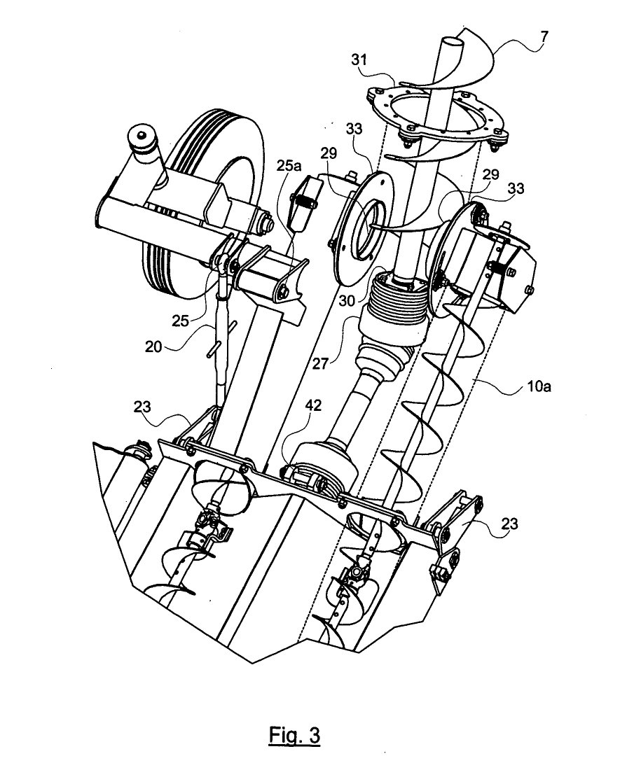

Turning to FIG. 3, one can easily view how the particulate material is moved upwardly through the rear smaller articulated conveyors and is discharged sideways into the main conveyor 7 by means of orifices 29. A configuration could also be used to discharge downwards into the main conveyor 7. The main conveyor has a face plate 30, which is attached to the stub section of the conveyor 27. The main conveyor pivot plate is shown as 31 which allows for rotational movement of the stub section conveyor casing, relative to the main conveyor casing around their longitudinal axes. The smaller casings 10 and 10a, are pivotally connected to the main conveyor stub tube 21 by means of articulating brackets 33. Casings 10 and 10a are also structured members rigidly attached to the platform. They also support the lower end of main conveyor 7. They also support the main axle frame tube 24. Extension and retraction of the transport wheels 3 is accomplished by rotating the main axle tube frame 24 around pivot points 25a.

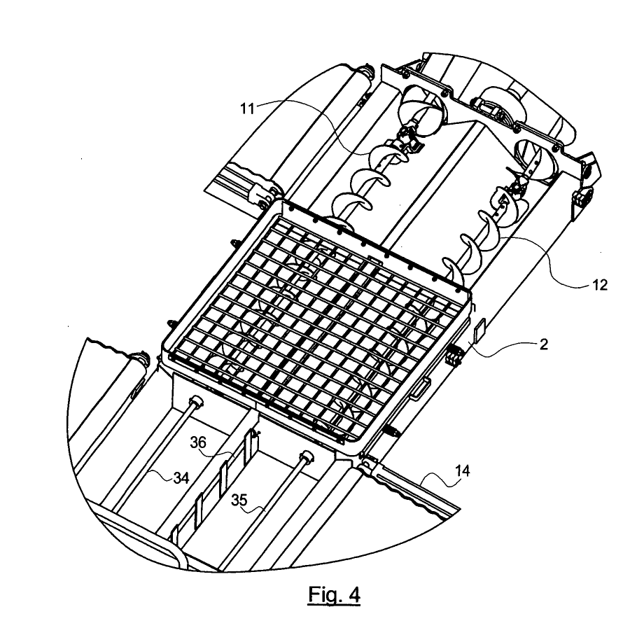

FIG. 4 is a cutaway view looking downwardly at the platform 2. There are three shafts for the augers: main auger shaft 36; right-hand transfer auger shaft 34; and left-hand transfer auger shaft 35. These are all moved by means of connections to power takeoff shaft 18a which is powered by the towing and power source, namely the agricultural tractor. These connections are not shown in detail as these are well known in the art.

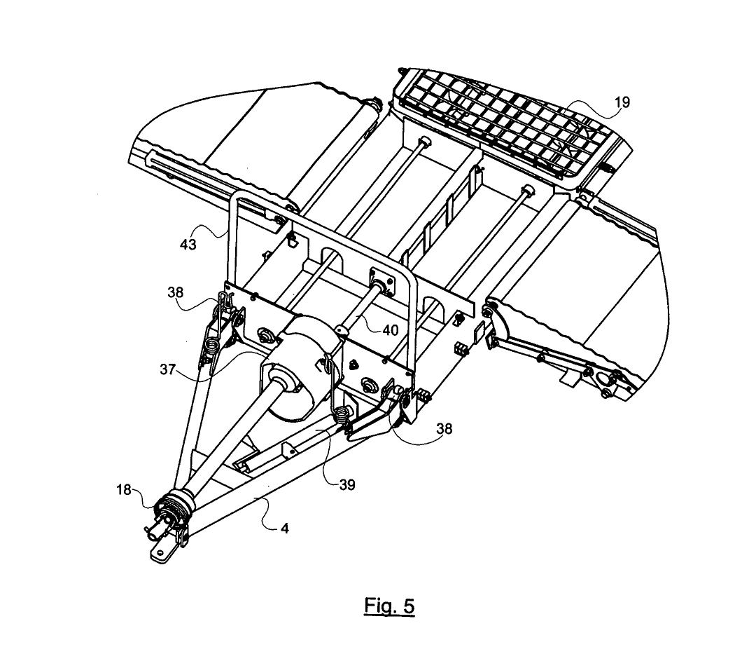

In FIG. 5, the hitch is hingable by means of a pivot hinge 38. Thus, to be discussed later, the front end of the hitch can be raised to allow the front portion of the platform to rest on the ground, and then lowered relative to the platform front end for a transport position. A manual hitch-jack can be used to move the front hitch when it is not attached to the power source. This manual hitch-jack is shown as 39. Also shown in FIG. 5 is a safety bar 43 which prohibits an operator from falling into the PTO shaft area.

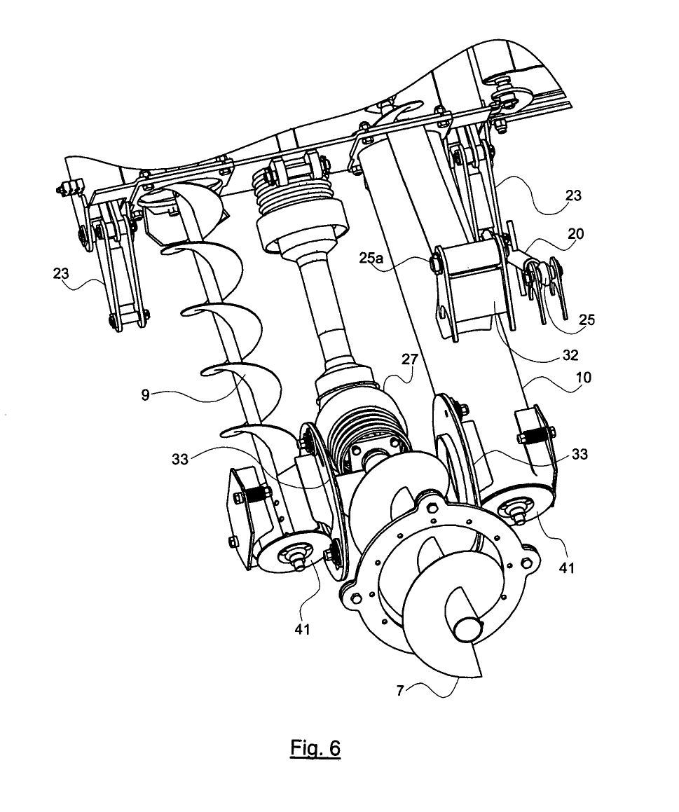

FIG. 6 is another view of the rear end of the device looking from above and from the rear. One notes that the conveyors 8 (not shown) and 9 are equipped with upper end plates 41.

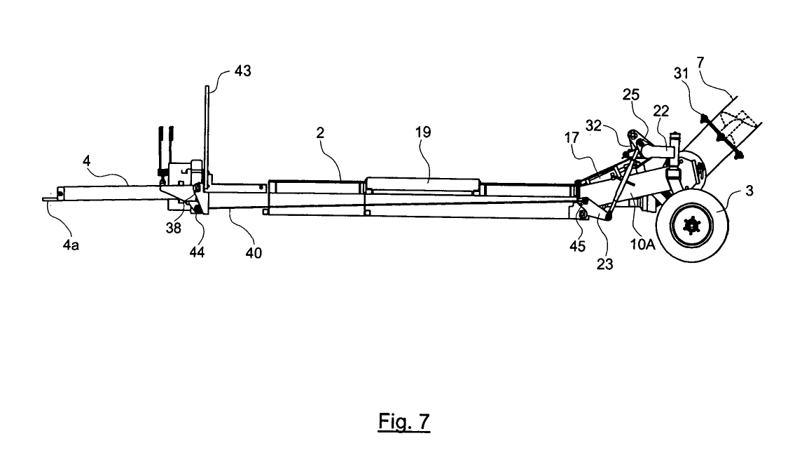

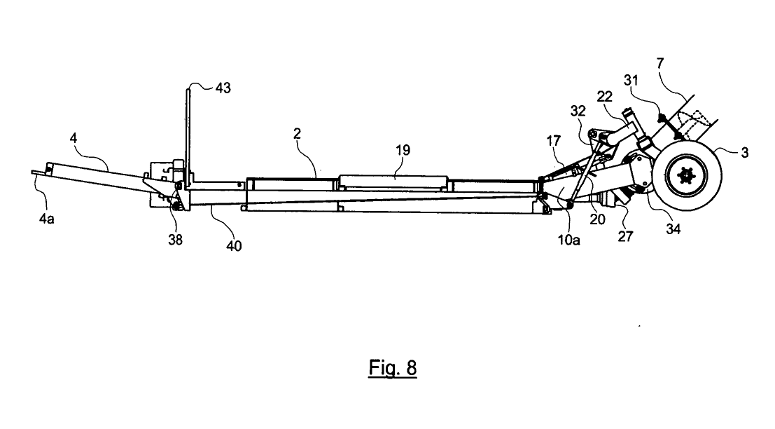

FIGS. 7 and 8 show the transport position of the device and the working or unloading position of the device respectively. In FIG. 7, the device is in the transport position. That is to say that hitch 4 extends straight out from platform 2. Hitch 4 is attached to an agricultural tractor by tongue 4a. In FIG. 7, the rear portion of the device is shown off the ground by means of hydraulics 17 which moves the wheels 3 downwardly and moving the rear of the platform upwardly. A link 40 connects the hitch 4 mechanism to the transport mechanism such that when the transport wheels are raised or lowered, similarly the hitch is moved upwardly or downwardly about hinge pivots 38. Link 40 is pivotally attached to the hitch at point 44 and at the rear of the device at point 45 located on bell crank 23. Turnbuckle attachment points 25 provide just the required amount of movement to properly drive bell cranks (links) 23 via turnbuckles 20 to properly move the hitch via link 40.

In order to allow the device to move to the working or unloading position, the main axle frame tube 24 is rotated by extension of hydraulic cylinder 17 which, at the same time, permits platform 2 to be placed firmly on the ground. At the same time, hitch 4 is raised at its forward end which allows the front portion of the platform 2 to rest firmly on the ground. The main conveyor 7 is always slightly supported above the ground, even in the unloading position. This prevents any damage to the articulated rear conveyors and the main conveyor 7.

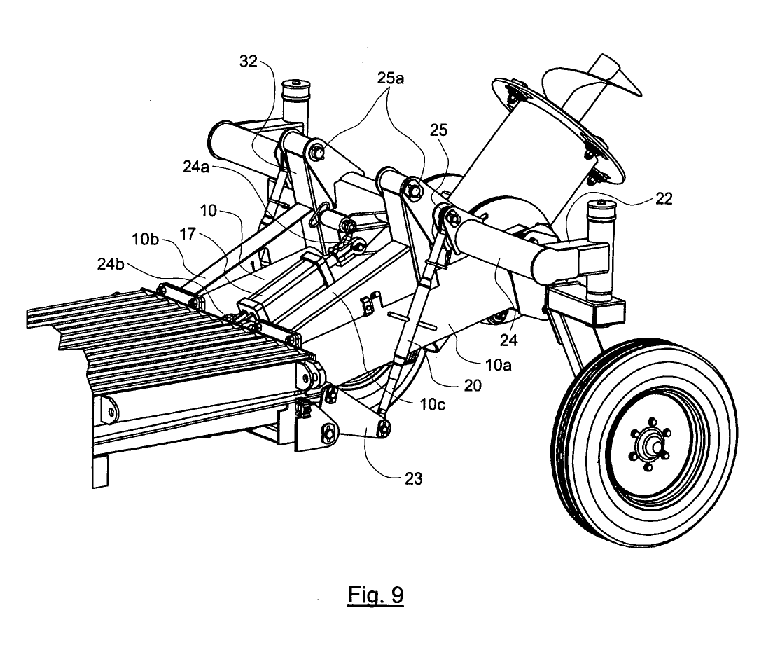

FIG. 9 shows a closeup of the rear end of the device in transport position. More clearly shown are the structured members 10b and 10c which are firmly attached to the platform and conveyor casings 10 and 10a respectively. Hydraulics 17 are pivotally attached at 24a and 24b.

It should be understood that conveyor casings 10, 10a and structural members 10b, 10c and 32 do not move relative to the platform 2. Only the main elevating conveyor 7, by means of articulated joints 33, is able to change its angle relative to the platform through the intermediary stub section 27.

Once the device is placed in the unloading position with the hitch raised at its front end and the hydraulics at the rear extended, power takeoff shaft 18a is activated and the shafts are placed in a rotating operating position. A particulate material transport truck is then driven over discharge opening 19 and the grain, via the conveyors, is elevated up into a bin or other area.

Thereafter, the process is reversed, the hydraulics retracted, the hitch and transport wheels lowered, and the operator can move the device to another position such that the main auger is positioned over another grain bin. The operator need never leave the cab of the power towing source, during active unloading and placement of the device to another location.

The foregoing is illustrative only of the principles of the invention. Further, since numerous changes and modifications will occur to those skilled in the art, it is not desired to limit the invention to the exact construction and operation shown and described, and accordingly, all such suitable changes and modifications in structure or operation which may be resorted to are intended to fall within the scope of the claimed invention.

1. An integrated particulate material transfer system adapted to be towed, positioned and activated by a motive power source, namely an agricultural tractor; said device including:
an elongated horizontally disposed platform;
said platform being supported at one end by at least one retractable castoring transport wheel, and at an opposite end, by a movable hitch; said hitch adapted to be connected to said motive power source and pivotally connected to said platform;
pivotally hydraulically operated attached ramps; and
said platform containing transfer means for conveying particulate material from the platform to a main transfer conveyor; wherein said motive power source and said integrated material transfer system, when used together, are always connected for both operation and transport.

2. An integrated mobile unloading and conveying device for particulate material adapted to be towed and activated by a motive power source, said device including:
an elongated horizontally disposed platform;
said platform being supported at one end by a pair of retractable castoring transport wheels, and at an opposite end by a hingedly connected hitch; said hitch adapted to be pivotally attached to said motive power source;
a rearward and a forward pair of hydraulically operable foldable ramps; said ramps being transverse to said platform, parallel to one another, and extending outwards from both sides of said platform;
at least one first horizontally disposed transfer conveyor located within said platform, and adapted in operation to move particulate material rearwardly within said platform;
said at least one transfer conveyor being connected by articulated joints to at least one obliquely disposed second transfer conveyor;
said at least one second transfer conveyor being connected at a remote end to a main elevating conveyor by a pivotal joint;
said at least one second transfer conveyor in operation adapted to discharge particulate material into said main conveyor;
said platform further including on its upper side a particulate material receiving aperture adapted to receive contents of a vehicle transporting particulate material;
said aperture being located between said forward pair and said rearward pair of ramps; and
wherein in operation, when said hitch is raised at its forward end and said transport wheels are retracted, said platform is in an operating unloading position adapted to receive and convey particulate material; and when said transport wheels are extended and said hitch lowered at its forward end, said device can be transported to another location such that a remote end of said main conveyor can be positioned to discharge its contents into a desired storage facility.

3. A device as claimed in claim 2 wherein said ramps are folded for transport.

4. A device as claimed in claim 2 wherein said transport wheels, said conveyors, said ramps, and said hitch are activated from the motive power source.

5. A device as claimed in claim 2 wherein said hitch and said transport wheels are connected by a mechanical link, adjusted by turnbuckles, such that when said wheels are retracted, said hitch is raised, and when said wheels are extended, said hitch is lowered.

6. A particulate material unloading system including:
a rigid platform resting on the surface of the ground, in an operational unloading position, for supporting a particulate material transporting vehicle where the longitudinal axis of said platform coincides with the direction of travel of a motive power source when said motive power source is moving in a straight line;
said platform being pivotally connected to said motive power source for moving said particulate material unloading system from one location to another;
said platform being capable of receiving particulate material discharged from said particulate material transporting vehicle;
a main particulate material conveyance device pivotally attached to said platform on the opposite end to which said motive power source is connected to said platform such that a longitudinal axis of said main particulate material conveyance device is substantially aligned with said longitudinal axis of said platform;
said main particulate material conveyance device being capable of delivering said particulate material to a holding bin; and
at least one secondary particulate material conveyance device for transferring said particulate material received by said platform to said main particulate material conveyance device, such that said platform remains connected to said motive power source and said main particulate material conveyance device during unloading and also when moving said particulate material unloading system from one area to another.

7. A particulate material unloading system as in claim 6 where said motive power source provides power required to transport said particulate material unloading system from one location to another and activates both said main and secondary material conveyance devices.

8. A platform as in claim 6 having upper, lower and side surfaces for receiving and containing said particulate material.

9. A platform as in claim 6 that has a semi-open upper surface allowing said particulate material to flow into said platform, and to said secondary material conveyance device.

10. A platform as in claim 6 where said platform has foldable ramps on both sides of said platform to reduce its transporting dimensions.

11. A platform as in claim 10 where said ramps are hydraulically foldable to reduce transport dimensions.

12. A platform as in claim 11 where power to hydraulically fold said platform to reduce transporting dimensions is provided by said motive power source.

13. A platform as in claim 6 constructed from steel.

14. A main particulate material conveyance device as in claim 6 that is a screw conveyor.

15. A main particulate material conveyance device as in claim 6 that is a belt conveyor.

16. A main particulate material conveyance device as in claim 6 that is a bucket elevator.

17. A main particulate material conveyance device as in claim 6 that is a paddle conveyor.

18. A secondary particulate material conveyance device as in claim 6 that is a screw conveyor.

19. A secondary particulate material conveyance device as in claim 6 that includes multiple screws.

20. A secondary particulate material conveyance device as in claim 6 that is a belt conveyor.

21. A secondary particulate material conveyance device as in claim 6 that is a paddle conveyor.

22. A system as in claim 6 where said motive power source provides power to said secondary conveyance device and said main particulate material conveyance device.

23. A system as in claim 6 that includes a truck positioning indicator.

24. A device as claimed in claim 2 wherein said at least one secondary particulate conveyance device includes two first transfer conveyors and two second transfer conveyors.
